(19) United States
(12) Patent Application Publication
(10) Pub. No.: US 2005/0123850 A1
(43) Pub. Date: Jun. 9, 2005

(54) THERMAL TRANSFER OF LIGHT-EMITTING DENDRIMERS

(75) Inventor: Martin B. Wolk, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/731,199

(22) Filed: Dec. 9, 2003

(51) Int. Cl. G03C 8/00

(52) U.S. Cl. 430/199; 430/200

(57) ABSTRACT

A method of making an organic electroluminescent device by thermally transferring a transfer portion of a donor element to a receptor, the transfer portion comprising at least one layer consisting of one or more light-emitting dendrimers.

### BACKGROUND

Thermal transfer of materials from a donor element to receptor has been proposed for various applications. For example, materials can be thermally transferred to form elements useful in electronic displays and other devices, and the thermal transfer of color filters, black matrix, spacers, polarizers, conductive layers, transistors, phosphors, and organic electroluminescent materials have all been suggested.

Light-emitting dendrimers have been described as an advantageous class of organic electroluminescent materials. Frequently, these materials have been applied to a substrate by solution-based processes such as spin-coating, although the thermal transfer of light-emitting dendrimers in combination with other components has also been reported.

### SUMMARY

In one aspect, the invention provides a method of making an organic electroluminescent device. The method comprises:
providing a donor element comprising a substrate and a transfer portion disposed on the substrate, the transfer portion comprising at least one transfer layer consisting of one or more light-emitting dendrimers (which may be fluorescent or phosphorescent);
providing a receptor; and
thermally transferring the transfer portion of the donor element to the receptor.

The donor element may further and optionally comprise a light-to-heat conversion layer disposed between the substrate and the transfer portion, an interlayer disposed between the light-to-heat conversion layer and the transfer portion, an underlayer disposed between the substrate and the light-to-heat conversion layer. The transfer portion may further and optionally comprise a second transfer layer; for example, a material that produces, conducts or semi-conducts a charge carrier.

The transfer portion may be thermally transferred from the donor element to the receptor by direct heating or by exposing the donor element to imaging radiation that is converted into heat (typically by a light-to-heat conversion layer). The donor element may be exposed to imaging radiation through a mask or to radiation that is generated by a laser. Optionally, the transfer portion of the donor may be thermally transferred to the receptor in an imagewise fashion to form a pattern on the receptor.

### BRIEF DESCRIPTION OF THE DRAWINGS

The invention will be more fully understood with reference to the following non-limiting drawings in which:

FIG. 1 is a schematic side view of a donor element for thermally transferring materials according to the invention; and

FIG. 2 is a schematic side view of an organic electroluminescent device that may be made according to the invention.

### DETAILED DESCRIPTION

This invention relates broadly to the thermal transfer of light-emitting dendrimers from a donor element to a receptor. More specifically, this invention relates to using thermal transfer techniques for manufacturing organic electroluminescent (OEL) devices comprising at least one transfer layer consisting of one or more light-emitting dendrimers.

Even more specifically, this invention relates to a method of making an OEL device, the method comprising providing a donor element that comprises a substrate and a transfer portion disposed on the substrate, providing a receptor, and thermally transferring the transfer portion of the donor element to the receptor. The transfer portion comprises at least one transfer layer consisting of one or more light-emitting dendrimers.

“Organic electroluminescent devices” are described more fully below and include completed devices, portions thereof, and layered assemblies that comprise a portion of a finished or unfinished device. Donor elements are also described more fully below and from which it will be clear that a transfer portion that is “disposed” on a substrate may be in direct contact with the substrate or may be supported by one or more layers interposed between the transfer portion and the substrate.

“Thermally transferring” refers to using heat to cause the transfer of the transfer portion of the donor element to the receptor, oftentimes forming a desired pattern on the receptor. The heat may be supplied directly or by converting other energy (such as light) into heat. Thermal transfer techniques are distinguished from non-thermal transfer methods such as inkjet printing, screen printing, spin-coating and photolithography.

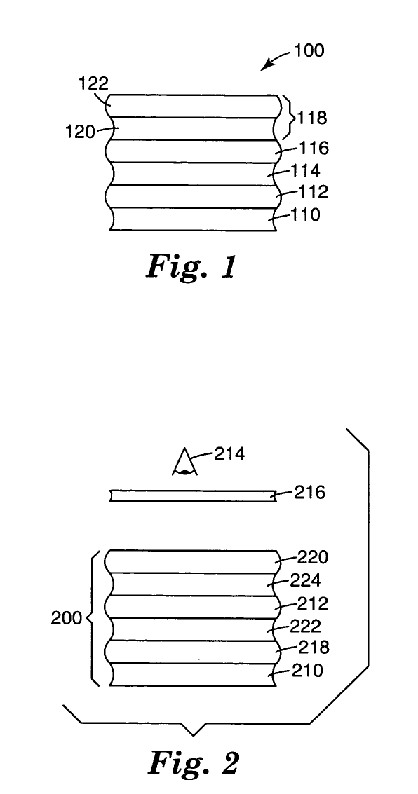

Turning now to the drawings, FIG. 1 shows one embodiment of a thermal transfer donor element 100 suitable for use in the present invention. Donor element 100 includes a substrate 110, an optional underlayer 112, an optional light-to-heat conversion (LTHC) layer 114, an optional interlayer 116, and a transfer portion 118 comprising a first transfer layer 120 consisting of one or more light-emitting dendrimers and an optional second transfer layer 122. Other layers may also be present in donor element 100. Donor elements are generally disclosed in International Publication No. 00/41893, and U.S. Pat. Nos.: 6,114,088; 5,998,085; 5,725,989; 6,228,555; and 6,284,425, although these references do not describe a transfer portion comprising at least one layer consisting of one or more light-emitting dendrimers.

Donor substrate 110 may be a polymer film. One suitable type of polymer film is a polyester film, for example, polyethylene terephthalate or polyethylene naphthalate. However, other films with sufficient optical properties, including high transmission of light at a particular wavelength, or sufficient mechanical and thermal stability properties, depending on the particular application, may also be used. The donor substrate, in at least some instances, is flat so that uniform coatings may be formed thereon. The donor substrate is also typically selected from materials that remain stable despite heating of one or more layers of the donor element. However, as described below, an underlayer 112 placed between donor substrate 110 and LTHC layer 114 can insulate the donor substrate from heat generated in the LTHC layer during imaging.

The typical thickness of donor substrate 110 ranges from about 0.025 to 0.15 mm, preferably from about 0.05 to 0.1 mm, although thicker or thinner donor substrates may be used. An optional priming layer may be used to increase uniformity during the coating of subsequent layers onto the substrate, and also to increase the bonding strength between donor substrate 110 and adjacent layers. Donor element substrate 110 may also include a roughened surface to improve the handling ability of the substrate during production of the donor element. Embedding inorganic particles such as silica particles in a primer layer can provide a primed polymeric substrate with good handling properties. One example of a suitable substrate with a primer layer is available from Teijin Ltd., Osaka, Japan, as Product No. HPE100. Another suitable substrate is Product No. M7Q available from DuPont Teijin Films, Hopewell, Va.

Optional underlayer 112 is disposed between donor substrate 110 and LTHC layer 114, and may comprise one or more individual layers. Underlayer 112 may control heat flow between the substrate and the LTHC layer during imaging or provide mechanical stability to donor element 100 for storage, handling, donor processing, or imaging. Underlayer 112 may be substantially transparent at the imaging wavelength, or may also be at least partially absorptive or reflective of the imaging radiation. Attenuation and/or reflection of imaging radiation by the underlayer may be used to control heat generation during imaging.

Underlayer 112 may be provided by a variety of inorganic (e.g., metallic) or organic materials. For example, any of a number of known polymers such as thermoset (crosslinked), thermosettable (crosslinkable), or thermoplastic polymers, including acrylates (including methacrylates), polyols (including polyvinyl alcohols), epoxy resins, silanes, siloxanes (with all types of variants thereof), polyvinyl pyrrolidones, polyimides, polyamides, poly (phenylene sulphide), polysulphones, phenol-formaldehyde resins, cellulose ethers and esters (for example, cellulose acetate, cellulose acetate butyrate, etc.), nitrocelluloses, polyurethanes, polyesters (for example, poly (ethylene terephthalate)), polycarbonates, polyolefins (for example, polyethylene, polypropylene, polychloroprene, polyisobutylene, polytetrafluoroethylene, polychlorotrifluoroethylene, poly (p-chlorostyrene), polyvinylidene fluoride, polyvinylchloride, polystyrene, etc.), phenolic resins (for example, novolak and resole resins), polyvinylacetates, and polyvinylidene chlorides may be used. Blends, mixtures, copolymers (i.e., two or more monomeric units arranged as random copolymers, graft copolymers, block copolymers, etc.), oligomers, macromers, etc. based on or derived from the foregoing, as well as polymerizable compositions comprising mixtures of the polymerizable active groups (for example, epoxy-siloxanes, epoxy-silanes, acryloyl-silanes, acryloyl-siloxanes, acryloyl-epoxies, etc.) are also contemplated.

Underlayer 112 may be applied by any suitable means, including coating, laminating, extruding, vacuum or vapor depositing, electroplating, and the like. For example, crosslinked underlayers may be formed by coating an uncrosslinked material onto donor substrate 110 and crosslinking the coating. Alternatively, a crosslinked underlayer may be initially formed and then laminated to the substrate subsequent to crosslinking. Crosslinking can take place by any means known in the art, including exposure to radiation and/or thermal energy and/or chemical curatives (water, oxygen, etc.).

The thickness of underlayer 112 is typically greater than that of conventional adhesion primers and release layers preferably greater than 0.1 micron, more preferably greater than 0.5 micron, most preferably greater than 1 micron. In some cases, particularly for metallic or other inorganic underlayers, the underlayer may be much thinner. For example, a thin metal underlayer that is at least partially reflective at the imaging wavelength may be useful in imaging systems where the donor element is irradiated from the transfer portion side. In other cases, the underlayer may be much thicker than these ranges, for example when the underlayer is included to provide some mechanical support for donor element 100.

Underlayer 112 may also include materials selected for their mechanical properties and/or their ability to improve adhesion between donor substrate 110 and adjacent LTHC layer 114 (if present). An underlayer that improves adhesion between the donor substrate and the LTHC layer may result in less distortion in the transferred image. As an example, an underlayer may reduce or eliminate delamination or separation of the LTHC layer that might otherwise occur during imaging of the donor element. This may reduce the amount of physical distortion exhibited by the transferred portion after transfer. In other cases, it may be desirable to employ an underlayer that promotes at least some separation between or among layers during imaging, for example to produce an air gap between layers during imaging that provides a thermal insulating function. Separation during imaging may also provide a channel for the release of gases that may be generated by heating of the LTHC layer during imaging. Such a channel may lead to fewer imaging defects.

With continued reference to FIG. 1, optional LTHC layer 114 may be included in donor element 100 to couple irradiation energy into the donor element. LTHC layer 114 preferably includes one or more radiation absorbers that absorb incident radiation (generally light in the infrared, visible or ultraviolet regions of the electromagnetic spectrum) and convert at least a portion of the incident radiation into heat to enable thermal transfer of transfer portion 118 from the donor element to a receptor. The radiation absorber is typically highly absorptive of the selected imaging radiation, providing an LTHC layer with an optical density at the wavelength of the imaging radiation in the range of about 0.2 to 3 or higher. Optical density of a layer is the absolute value of the logarithm (base 10) of the ratio of the intensity of light transmitted through the layer to the intensity of light incident on the layer.

The radiation absorber is often incorporated into a binder and may be uniformly disposed throughout the LTHC layer or it may be non-homogeneously distributed. Non-homogeneous LTHC layers may be used to control temperature profiles in donor elements and may give rise to donor elements that have improved transfer properties (e.g., better fidelity between the intended transfer pattern and the actual transfer pattern). Suitable radiation absorbers include dyes, pigments, metals and other suitable absorbing materials.

Dyes suitable for use as radiation absorbers include visible dyes, ultraviolet dyes, infrared dyes, fluorescent dyes, and radiation-polarizing dyes. A specific dye is often chosen based on factors such as solubility in, and compatibility with, a specific binder or coating solvent, as well as the wavelength range of absorption. The dyes may be present in particulate form, dissolved in a binder material, or at least partially dispersed in a binder material. When dispersed particulate radiation absorbers are used, the particle size may be about 10 μm or less, and may be about 1 μm or less.

Pigments may also be used as radiation absorbers and suitable examples include carbon black and graphite, as well as phthalocyanines, nickel dithiolenes, and other pigments described in U.S. Pat. Nos. 5,166,024 and 5,351,617. A pigment, such as carbon black, dispersed in a binder, such as an organic polymer, is quite useful. Additionally, black azo pigments based on copper or chromium complexes of, for example, pyrazolone yellow, dianisidine red, and nickel azo yellow, may be useful. Inorganic pigments may also be used, including oxides and sulfides of metals such as aluminum, bismuth, tin, indium, zinc, titanium, chromium, molybdenum, tungsten, cobalt, iridium, nickel, palladium, platinum, copper, silver, gold, zirconium, iron, lead and tellurium. Metal borides, carbides, nitrides, carbonitrides, bronze-structured oxides, and oxides structurally related to the bronze family (e.g., WO_{2.9}) may also be used.

Metal radiation absorbers may be used in the form of particles as described, for instance, in U.S. Pat. No. 4,252,671. Suitable metal radiation absorbers include aluminum, bismuth, tin, indium, tellurium and zinc, and metal compounds such as metal oxides, metal sulfides, and the materials described above as inorganic pigments.

Suitable binders for use in LTHC layer 114 include film-forming polymers such as phenolic resins (e.g., novolak and resole resins), polyvinyl butyral, polyvinyl acetates, polyvinyl acetals, polyvinylidene chlorides, polyacrylates, cellulosic ethers and esters, nitrocelluloses, polyacrylics, styrene-acrylics, and polycarbonates. Suitable binders may include monomers, oligomers or polymers that have been, or that can be, polymerized or crosslinked. Additives such as photoactive curatives may also be included to facilitate crosslinking of the LTHC binder. In some embodiments, the binder is primarily formed using a coating of crosslinkable monomers or oligomers with optional polymer.

The inclusion of a thermoplastic resin (e.g., polymer) may improve the performance (e.g., transfer properties or coatability) of LTHC layer 114 and may improve the adhesion of the LTHC layer to the donor element substrate or other adjacent layer. In one embodiment, the binder includes 25 to 50 wt. % (excluding the solvent when calculating weight percent) thermoplastic resin, preferably, 30 to 45 wt. % thermoplastic resin, although lower amounts of thermoplastic resin may also be used (e.g., 1 to 15 wt. %). The thermoplastic resin is typically chosen to be compatible (i.e., form a one-phase combination) with the other materials of the binder. In at least some embodiments, a thermoplastic resin that has a solubility parameter in the range of 9 to 13 (cal/cm³)^{1/2}, preferably 9.5 to 12 (cal/cm³)^{1/2}, is chosen for the binder.

LTHC layers that include a particulate radiation absorber incorporated into a binder may be applied by any suitable dry or wet coating technique. Conventional coating aids, such as surfactants and dispersing agents, may be added to facilitate the coating process. LTHC layer 114 may be applied to donor element substrate 110 using a variety of coating methods known in the art. A polymeric or organic LTHC layer may be coated to a thickness of about 0.05 μm to 20 μm, preferably about 0.5 μm to 10 μm, and more preferably about 1 μm to 7 μm.

LTHC layer 114 may be provided as a thin metal film (for example, as disclosed in U.S. Patent No. 5,256,506) and may be formed from those materials described above as particulate metal radiation absorbers as appropriate. Metal films may be formed by techniques such as sputtering and evaporative deposition to a thickness of about 0.0005 to 10 μm, preferably about 0.001 to 1 μm. One suitable LTHC layer includes metal or metal/metal oxide formed as a thin film, for example, black aluminum (i.e., a partially oxidized aluminum having a black visual appearance).

Combinations of the foregoing materials may also be used to provide LTHC layer 114. For example, LTHC layer 114 may comprise two or more LTHC layers containing similar or dissimilar materials such as an LTHC layer formed by vapor depositing a thin layer of black aluminum over a coating that contains carbon black dispersed in a binder.

Still referring to FIG. 1, optional interlayer 116 may be disposed between LTHC layer 114 and transfer portion 118, and may comprise one or more individual layers. The interlayer may be used to minimize damage and contamination and/or reduce distortion in or mechanical damage of the transferred part of the transfer portion. Interlayer 116 may also influence the adhesion of transfer portion 118 to other layers that comprise donor element 100. Interlayer 116 may be a barrier against the transfer of material from LTHC layer 114. The interlayer may also act as a barrier to prevent any material or contamination exchange to or from layers proximate thereto. It may also modulate the temperature attained in transfer portion 118 so that thermally unstable materials may be transferred. For example, interlayer 116 may act as a thermal diffuser to control the temperature at the interface between interlayer 116 and transfer portion 118 relative to the temperature attained in LTHC layer 114. This may improve the quality (i.e., surface roughness, edge roughness, etc.) of the transferred portion. The presence of interlayer 116 may also result in improved plastic memory in the transferred material.

Typically, the interlayer has high thermal resistance. Preferably, the interlayer does not distort or chemically decompose under the imaging conditions, particularly to an extent that renders the transferred image non-functional. Interlayer 116 typically remains in contact with LTHC layer 114 during the transfer process and is not substantially transferred with transfer portion 118.

Interlayers may be formed of organic materials, inorganic materials, and organic/inorganic composites, and may be transmissive, absorbing, reflective, or some combination thereof, at the imaging radiation wavelength.

Organic materials suitable for use in the interlayer include both thermoset and thermoplastic materials. Suitable thermoset materials include resins that may be crosslinked by heat, radiation or chemical treatment including, crosslinked or crosslinkable polymers such as polyacrylates, polymethacrylates, polyesters, epoxies and polyurethanes. The thermoset materials may be applied to the LTHC layer as, for example, thermoplastic precursors that are subsequently crosslinked to form a crosslinked interlayer.

Suitable thermoplastic materials for the interlayer include polymers such as polyacrylates, polymethacrylates, polystyrenes, polyurethanes, polysulfones, polyesters and polyimides. The thermoplastic materials may be applied via conventional coating techniques (for example, solvent coating, spray coating or extrusion coating). Typically, the glass transition temperature (T_{g}) of the thermoplastic material is 25° C. or greater, preferably 50° C. or greater. In some embodiments, the interlayer includes a thermoplastic material that has a T_{g} greater than any temperature attained in the transfer portion during imaging. The interlayer may be either transmissive, absorbing, reflective, or some combination thereof, at the wavelength of the imaging radiation.

Inorganic materials suitable for use in the interlayer include metals, metal oxides, metal sulfides, inorganic carbon coatings and other inorganic layers (e.g., sol-gel deposited layers and vapor deposited layers of inorganic oxides (e.g., silica, titania, and other metal oxides)). These materials may be applied via conventional techniques (e.g., vacuum sputtering, vacuum evaporation, or vapor deposition, or plasma jet deposition).

Interlayer 116 may contain additives such as photoinitiators, surfactants, pigments, plasticizers and coating aids. The thickness of interlayer 116 may depend on factors such as the material of the interlayer, the material and properties of LTHC layer 114, the material and properties of transfer portion 118, the wavelength of the imaging radiation, and the duration of exposure of the donor element to imaging radiation. For organic interlayers, the thickness typically is about 0.05 μm to 10 μm. For inorganic interlayers, the thickness typically is about 0.005 μm to 10 μm. Multiple interlayers may also be used; for example, an organic-based interlayer may be covered by an inorganic-based interlayer to provide additional protection to the transfer portion during the thermal transfer process.

With continuing reference to FIG. 1, thermal transfer portion 118 comprises first transfer layer 120 that consists of one or more light-emitting dendrimers, and optional second transfer layer 122. Although first transfer layer 120 is illustrated in FIG. 1 as being intermediate second transfer layer 122 and optional interlayer 116, the invention is not so limited. The relative positions of first transfer layer 120 and optional second transfer layer 122 (if present) may be reversed. Alternatively, second transfer layer 122 may be provided by several separate layers at least one of which is disposed on each side of first transfer layer 120.

Light-emitting dendrimers are dendrimeric compounds that are light emissive (i.e., they are electroluminescent). While not intending to be bound by this theory, one mechanism of electroluminescence has been described as involving the “injection of electrons from one electrode and holes from the other, the capture of oppositely charged carriers (so-called recombination), and the radiative decay of the excited electron-hole state (exciton) produced by this recombination process.” (See, R. H. Friend, et al., “Electroluminescence in Conjugated Polymers,” Nature, 397, 1999, 121.)

Dendrimeric compounds are successively branched macromolecules emanating from a core moiety and comprise the core moiety, surface groups, and branches that link the surface groups to the core moiety. Advantageously, the properties of the dendrimer may be tailored by judicious selection of the core moiety, the surface groups, and the branches. The core moiety is often associated with the electronic properties of the dendrimer, such as its light emissive characteristics (e.g., the color of the emitted light), in which event the photoactive element of the dendrimer is located in the core moiety. However, the photoactive element may be located in any one or more of the core moiety, the surface groups, and the branches, as well as being non-covalently associated with the dendrimer structure or on its surface. The surface groups may be selected to control the processing properties of the dendrimer, such as the solvent solubility of the dendrimer. The branches allow charge and excited states to be transported to the core moiety where they can be trapped. Dendrimers useful in the invention comprise at least one branch, and more preferably three or more branches that may be the same or different. The core moiety and the branches may be conjugated or non-conjugated. The dendrimer may be designed to be fluorescent or phosphorescent.

The following publications disclose light-emitting dendrimers useful in the present invention: International Publication No. WO 99/21935; International Publication No. WO 02/066552; U.S. Publication No. US 2003/0134147 A1; Ma et al., Novel Heterolayer Organic Light-Emitting Diodes Based on a Conjugated Dendrimer, Adv. Funct. Mater., 2002, 12, No. 8, August; Jiang et al., Efficient Emission from a Europium Complex Containing Dendron-Substituted Diketone Ligands, Thin Solid Films, 416 (2002), 212-217; Halim et al., Conjugated Dendrimers for Light-Emitting Diodes: Effect of Generation, Adv. Mater., 11(5) 1999, 371-374; Lo et al., Green Phosphorescent Dendrimer for Light-Emitting Diodes, Adv. Mater., 2002, 14, No. 13-14, July 4; Kwok et al., Synthesis and Light-Emitting Properties of Difunctional Dendritic Distyrylstilbenes, Macromolecules 2001, 34, 6821-6830; Adronov et al., Light-Harvesting Dendrimers, Chem. Commun., 2000, 1701-1710; Shirota, Organic Materials for Electronic and Optoelectronic Devices, J. Mater Chem., 2000, 10 1-25; Halim et al., Control of Colour and Charge Injection in Conjugated Dendrimer/Polypyridine Bilayer LEDs, Synthetic Metals, 102 (1999), 1571-1574; Balzani, et al., Dendrimers Based on Photoactive Metal Complexes, Recent Advances, Coordination Chemistry Review, 219-221, 2001, 545; and Inoue, et al., Functional Dendrimers, Hyperbranched and Star Polymers, Prog. Polym. Sci. 25, 2000, 453.

In another embodiment, first transfer layer 120 may contain one or more light-emitting dendrimers and one or more species that are not light-emitting (i.e., a small molecule, dendrimer, oligomer or polymer that is either electrically active or inert).

Second transfer layer 122 may include any material suitable for inclusion in an organic electroluminescent (OEL) device, disposed in one or more individual layers, alone or in combination with other materials. In many cases, materials used in second transfer layer 122 are electrically active. In the context of the present invention, “electrically active” describes organic materials that perform a function during the operation of an OEL device made therewith; for example, producing, conducting, or semi-conducting a charge carrier (e.g., electrons or holes), producing light, enhancing or tuning the electronic properties of the device construction, and the like. Electrically active materials may be distinguished from “non-active” materials, which although not directly contributing to the functions described above, may indirectly contribute to the assembly, fabrication or functioning of the OEL device.

The electrically active materials may be small molecule or polymeric in nature. Small molecule materials are generally non-polymeric organic or organometallic materials that can be used in OEL displays and devices as emitter materials, charge transport materials, as dopants in emitter layers (e.g., to control the emitted color) or charge transport layers, and the like. Commonly used small molecule materials include metal chelate compounds, such as tris(8-hydroxyquinoline) aluminum (Alq₃), and N,N′-bis(3-methylphenyl)-N,N′-diphenylbenzidine (TPD). Other small molecule materials are disclosed in, for example, C. H. Chen, et al., Macromol. Symp. 125, 1 (1997), Japanese Laid Open Patent Application 2000-195673, U.S. Pat. Nos. 6,030,715, 6,150,043, and 6,242,115, and International Publication Nos. WO 00/18851 (divalent lanthanide metal complexes), WO 00/70655 (cyclometallated iridium compounds and others), and WO 98/55561. Classes of polymeric materials commonly used as charge transporting materials (e.g., hole transporting polymers, electron transporting polymers, and mixed hole and electron transporting polymers) include polythiophenes, poly(triarylamines), and poly(oxadiazoles) in which the electrically active species is in the polymer chain or pendant to the polymer chain.

Those electrically active materials that are light producing are useful and include small molecule emitters, small molecule doped polymers, light-emitting polymers, light-emitting dendrimers, and other organic emissive materials. These materials may be provided alone or in combination with other organic or inorganic materials that are functional or non-functional in the OEL device made therewith. Classes of suitable light emitting polymers include poly(phenylenevinylene)s, poly-para-phenylenes, polyfluorenes, and co-polymers or blends thereof. Suitable light emitting polymers may also be molecularly doped, dispersed with fluorescent dyes or other photoactive materials, blended with active or non-active materials, dispersed with active or non-active materials, and the like. Examples of suitable light emitting polymers are described in: Kraft, et al., Angew. Chem. Int. Ed., 37, 402-428 (1998); U.S. Pat. Nos.: 5,621,131; 5,708,130; 5,728,801; 5,840,217; 5,869,350; 5,900,327; 5,929,194; 6,132,641; and 6,169,163; and International Publication No. WO 99/40655.

Generally, small molecule materials may be vacuum deposited or evaporated to form one or more thin layers. Polymeric materials may be applied by solution coating a thin layer of the polymer. If multiple layers of polymeric material are to be applied, the layers are cast from different solvents, a first insoluble layer is created in situ and a second layer is solvent cast, a first layer is solution cast and a second layer is vapor deposited, or one or both of the layers is crosslinked.

Examples of other materials that may be included in second transfer layer 122 include colorants (e.g., pigments and/or dyes dispersed in a binder), polarizers, liquid crystal materials, particles, insulating materials, conductive materials, charge transport materials, charge injection materials, hydrophobic materials, hydrophilic materials, multilayer stacks (e.g., layers suitable for multilayer device constructions), microstructured or nanostructured layers, photoresist, metals, polymers, adhesives, binders, etc. These and other transfer layers are disclosed in the following documents: U.S. Pat. Nos.: 6,114,088; 5,998,085; 5,725,989; 5,710,097; 5,693,446; 5,691,098; 5,685,939; and 5,521,035; and International Publication Nos. WO 97/15173, WO 99/46961, and WO 00/41893.

As noted above and according to the present invention, transfer portion 118 may be thermally transferred from donor element 100 to a receptor. Transfer portion 118 may be thermally transferred as a unit or in portions by any suitable thermal transfer process, whether donor element 100 is directly heated or exposed to imaging radiation that can be absorbed by LTHC layer 114 and converted into heat.

Direct heating of donor element 100 may be achieved with, for example, a thermal print head or other heating element that directly heats the donor element, thereby transferring the desired parts of transfer portion 118 to the receptor. Advantageously, the thermal print head or other heating element may be configured or patterned so as to selectively heat the donor element and effect transfer of the transfer portion to the receptor in a corresponding configuration or pattern. Thermal print heads and other heating elements are particularly well suited for preparing devices for lower resolution information displays, including segmented displays, emissive icons, and the like. When direct heating thermal transfer techniques are employed, LTHC layer 114 is optional.

Alternatively, and more preferably, thermal transfer of transfer portion 118 may be achieved by exposing donor element 100 to imaging radiation. Transfer portion 118 of donor element 100 is placed adjacent to the receptor and the donor element is exposed to imaging radiation that can be absorbed by LTHC layer 114 and converted into heat. Donor element 100 may be exposed to the imaging radiation through donor substrate 110, or through the receptor, or both. The imaging radiation may include one or more wavelengths, including visible light, infrared radiation, or ultraviolet radiation, generated by, for example, a laser, lamp, or other radiation source.

If desired, transfer portion 118 may be selectively transferred to the receptor to imagewise form patterns of the transferred material on the receptor. In these instances, using radiation emitted by, for example, a laser or a lamp, may be particularly advantageous because of the accuracy and precision that can be achieved. The size and the shape of the transferred pattern (e.g., a line, circle, square, or other shape) may be desirably controlled by, for example, selecting the width of the light beam, the exposure pattern of the light beam, the duration of directed beam contact with the donor element, and/or the materials of the donor element. The size and shape of the transferred pattern may also be controlled by irradiating the donor element through a mask configured in a manner that corresponds to desired pattern.

Thermal transfer using the radiation emitted from a laser is described in, for example, U.S. Pat. Nos.: 6,242,152; 6,228,555; 6,228,543; 6,221,553; 6,221,543; 6,214,520; 6,194,119; 6,114,088; 5,998,085; 5,725,989; 5,710,097; 5,695,907; 5,693,446; 6,485,884; 6,358,664; 6,284,425; and 6,521,324.

A variety of radiation-emitting sources may be used to heat donor element 100. For analog techniques (e.g., exposure through a mask), high-powered light sources (e.g., xenon flash lamps and lasers) are useful. In other instances, digital imaging techniques employing infrared, visible or ultraviolet lasers are useful.

A laser is an especially desired radiation source when high spot placement accuracy is required (e.g., for high information full color displays) over large areas. Lasers are compatible with both large rigid substrates (e.g., 1 m×1 m×1.1 mm glass), and continuous or sheeted film substrates (e.g., 100 μm thick polyimide sheets). Suitable lasers include high power (≧100 mW) single mode laser diodes, fiber-coupled laser diodes, and diode-pumped solid state lasers (e.g., Nd:YAG and Nd:YLF). Laser exposure dwell times may vary widely from, for example, a few hundredths of a microsecond to tens of microseconds or more, and laser fluences may range from, for example, about 0.01 to about 5 J/cm² or more. Other radiation sources and radiation exposure conditions may be suitable based on factors such as the donor element construction, materials used in the transfer portion, the mechanism of thermal transfer, etc.

During imaging, donor element 100 may be brought into intimate contact with the receptor, and pressure or vacuum may be used to hold the donor element in intimate contact with the receptor. In other instances, the donor element may be spaced from the receptor. In some instances, a mask may be placed between the donor element and the receptor. The mask may be removable or may remain on the receptor after transfer. A radiation source is then used to heat LTHC layer 114 (and/or other layer(s) containing radiation absorber) in an imagewise fashion (e.g., digitally or by analog exposure through a mask) to transfer the transfer portion from the donor element to the receptor. If desired, transfer portion 118 may be selectively transferred to the receptor to imagewise form patterns of the transferred material on the receptor.

Typically, selected areas of transfer portion 118 are transferred to the receptor without transferring significant portions of the other layers of donor element 100, such as interlayer 116 or LTHC layer 114. Interlayer 116 may eliminate or reduce the transfer of material from LTHC layer 114 to the receptor and/or reduce distortion in the transferred areas of transfer portion 118. Preferably, under imaging conditions, the adhesion of interlayer 116 to LTHC layer 114 is greater than the adhesion of interlayer 116 to transfer portion 118. In some instances, a reflective interlayer may be used to attenuate the level of imaging radiation transmitted through the interlayer and reduce any damage to the transferred areas of the transfer portion that may result from interaction of the transmitted radiation with the transfer portion and/or the receptor. This is particularly beneficial in reducing thermal damage that may occur when the receptor is highly absorptive of the imaging radiation.

Large donor elements may be used, including donor elements that have length and width dimensions of a meter or more. In operation, a laser can be rastered or otherwise moved across a large donor element, the laser being operated to selectively illuminate portions of the donor element according to a desired pattern. Alternatively, the laser may be stationary and the donor element and/or receptor moved beneath the laser.

As noted above, transfer portion 118 of donor element 100 is thermally transferred to a suitable receptor. The receptor may be any surface suitable for the intended application (for example, any type of substrate or display element suitable for OEL device and display applications), and may be transparent or opaque to visible light. Appropriate receptors include glass, transparent films, reflective films, metals (e.g., stainless steel), semiconductors (e.g., silicon, polysilicon), and various papers and plastics. Receptors suitable for use in displays such as liquid crystal displays or emissive displays are of particular interest and include rigid or flexible substrates that are substantially transmissive to visible light. Examples of suitable rigid receptors include silicon, quartz, glass and rigid plastic that are coated or patterned with indium tin oxide and/or are circuitized with low temperature polysilicon or other transistor structures, including organic transistors.

Suitable flexible substrates include substantially clear and transmissive polymer films, reflective films, transflective films, polarizing films, multilayer optical films, and the like. Flexible substrates can also be coated or patterned with electrode materials or transistors, for example transistor arrays formed directly on the flexible substrate or transferred to the flexible substrate after being formed on a temporary carrier substrate. Suitable polymer substrates include polyester films (e.g., polyethylene terephthalate, polyethylene naphthalate), polycarbonate films, polyolefin films, polyvinyl films (e.g., polyvinyl chloride, polyvinylidene chloride, polyvinyl acetals, etc.), cellulose ester films (e.g., cellulose triacetate, cellulose acetate), and other conventional polymeric films used as supports. For making OELs on plastic substrates, it is often desirable to include a barrier film or coating on one or both surfaces of the plastic substrate to protect the organic light emitting devices and their electrodes from exposure to undesired levels of water, oxygen, and the like.

Receptors can be pre-patterned with any one or more of electrodes, transistors, capacitors, insulator ribs, spacers, color filters, polarizers, wave plates, diffusers and other optical components, black matrix, hole transport layers, electron transport layers, and other elements useful for electronic displays or other devices. Generally, one or more electrodes will be coated, deposited, patterned, or otherwise disposed on the receptor before forming the remaining layer or layers of the device.

The present invention may be used to form a wide variety of OEL devices, including organic light emitting diodes or portions thereof. The receptor substrate comprises a portion of the OEL device, as does transfer portion 118 that is thermally transferred to the receptor from donor element 100.

Turning now to FIG. 2, reference numeral 200 designates an illustrative OEL device made according to the invention and comprising an emissive layer 210 consisting of one or more light-emitting dendrimers and a substrate 212 on which emissive layer 210 is disposed. OEL device 200 was made by thermally transferring emissive layer 210 from a donor element to a receptor. With reference to FIG. 1, first transfer layer 120 provided emissive layer 210, and the receptor to which it was thermally transferred provided substrate 212.

Though not shown in FIG. 2, various components suitable for use with OEL devices may be incorporated into OEL device 200 in any suitable manner. For example, in lamp applications (e.g., backlights for liquid crystal displays), OEL device 200 might constitute a single OEL component that spans an entire intended backlight area. Alternatively, in other lamp applications, OEL device 200 might constitute a plurality of closely spaced components that can be contemporaneously activated. For example, relatively small and closely spaced red, green and blue light emitters may be patterned between common electrodes so that OEL device 200 appears to emit white light when the emitters are activated. Other arrangements for backlight applications are also possible.

In direct view or other display applications, it may be desirable for OEL device 200 to include a plurality of independently addressable OEL components that emit the same or different colors. Each device might represent a separate pixel or a separate sub-pixel of a pixelated display (e.g., a high resolution display), a separate segment or sub-segment of a segmented display (e.g., a low information content display), or a separate icon, portion of an icon, or lamp for an icon (e.g., indicator applications).

Other layers that may also be present in OEL devices include hole transport layers, electron transport layers, hole injection layers, electron injection layers, hole blocking layers, electron blocking layers, buffer layers, and the like. In addition, photoluminescent materials may be present in emissive or other layers in OEL devices, for example, to convert the color of the emitted light to another color. These and other such layers and materials may be used to alter or tune the electronic properties and behavior of the OEL device, for example to achieve a desired current/voltage response, a desired device efficiency, a desired color, a desired brightness, and the like.

Similarly, and with continued reference to FIG. 2, various elements suitable for use with OEL devices may be positioned between OEL device 200 and viewer position 214, this being denominated generally in FIG. 2 as optional element 216. Element 216 may be any element or combination of elements suitable for use with OEL device 200. For example, element 216 may be an LCD module when OEL device 200 is a backlight. One or more polarizers or other elements may be provided between the LCD module and the backlight, for instance an absorbing or reflective clean-up polarizer. Alternatively, when OEL device 200 is itself an information display, element 216 may include one or more polarizers, wave plates, touch panels, antireflective coatings, anti-smudge coatings, projection screens, brightness enhancement films, or other optical components, coatings, user interface devices, and the like.

Still referring to FIG. 2, OEL device further comprises anode 218, cathode 220, hole transport layer 222, and electron transport layer 224. Anode 218 and cathode 220 are typically formed using electrically conducting materials such as metals, alloys, metallic compounds, metal oxides, conductive ceramics, conductive dispersions, and conductive polymers, including, for example, gold, platinum, palladium, aluminum, calcium, titanium, titanium nitride, indium tin oxide, fluorine tin oxide, and polyaniline. Anode 218 and cathode 220 may be single layers of electrically conducting material or multiple layers. For example, an anode or a cathode may include a layer of aluminum and a layer of gold, a layer of calcium and a layer of aluminum, a layer of aluminum and a layer of lithium fluoride, or a metal layer and an electrically conductive organic layer.

Hole transport layer 222 facilitates the injection of holes from anode 218 into OEL device 200 and their migration toward the recombination zone. Hole transport layer 222 may further act as a barrier for the passage of electrons to anode 218. Materials suitable for use as hole transport layer 222 include a diamine derivative such as N,N′-bis(3-methylphenyl)-N,N′-bis(phenyl)benzidine or N,N′-bis(3-naphthalen-2-yl)-N,N′-bis(phenyl)benzidine, or a triarylamine derivative such as 4,4′,4″-Tris(N,N-diphenylamino)triphenylamine or 4,4′,4″-Tris(N-3-methylphenyl-N-phenylamino)triphenylamine. Other suitable materials include copper phthalocyanine, 1,3,5-Tris(4-diphenylaminophenyl)benzenes, and compounds such as those described in H. Fujikawa, et al., Synthetic Metals, 91, 161 (1997) and J. V. Grazulevicius, P. Strohriegl, “Charge-Transporting Polymers and Molecular Glasses,” Handbook of Advanced Electronic and Photonic Materials and Devices, H. S. Nalwa (ed.), 10, 233-274 (2001).

Electron transport layer 224 facilitates the injection of electrons from cathode 220 and their migration toward the recombination zone. Electron transport layer 224 may further act as a barrier for the passage of holes to cathode 220. Electron transport layer 224 may be formed using the organometallic compound tris(8-hydroxyquinolato) aluminum; 1,3-bis[5-(4-(1,1-dimethylethyl)phenyl)-1,3,4-oxadiazol-2-yl]benzene; 2-(biphenyl-4-yl)-5-(4-(1,1-dimethylethyl)phenyl)-1,3,4-oxadiazole; and compounds described in C. H. Chen, et al., Macromol. Symp. 125, 1 (1997) and J. V. Grazulevicius, P. Strohriegl, “Charge-Transporting Polymers and Molecular Glasses”, Handbook of Advanced Electronic and Photonic Materials and Devices, H. S. Nalwa (ed.),10, 233 (2001).

One or more of anode 218, cathode 220, hole transport layer 222, and electron transport layer 224 may be provided on OEL device 200 as a result of having been thermally transferred from donor element 100, where these layers comprised second transfer layer 122. In some instances, however, it may be necessary, desirable and/or convenient to sequentially use two or more different donor elements to form OEL devices on a receptor. For example, multiple layer devices may be formed by transferring separate layers or separate stacks of layers from different donor elements. (Multilayer stacks may also be transferred as a single transfer unit from a single donor element.) Examples of multilayer OEL devices include organic electroluminescent pixels and/or devices such as organic light-emitting diodes (OLEDs). Multiple donor elements may also be used to form separate OEL devices in the same layer on the receptor. For example, three different donor elements, each having a transfer portion comprising an organic electroluminescent material that emits a different color (for example, red, green and blue) may be used to form RGB sub-pixel OLED elements for a color electronic display. Also, separate donor elements, each having multiple layer transfer portions, may be used to pattern different multilayer OEL devices (e.g., OLEDs that emit different colors, OLEDs that connect to form addressable pixels, etc.).

Typically, materials from separate donor elements are transferred adjacent to other materials on a receptor to form adjacent devices, portions of adjacent devices, or different portions of the same device. Alternatively, materials from separate donor elements may be transferred directly on top of, or in partial overlying registration with, other layers or materials previously patterned onto the receptor, whether by thermal transfer or other methods. A variety of other combinations of two or more donor elements may be used to form an OEL device, each donor element forming one or more portions of the device. It will be understood that other portions of these devices, or other devices on the receptor, may be formed in whole or in part by any suitable process including photolithographic processes, ink jet processes, spin-coating, and various other printing or mask-based processes.

### EXAMPLE 1

The present invention is illustrated by and will be more fully appreciated with reference to the following non-limiting example in which, unless otherwise specified, all parts are parts by weight, and all ratios and percentages are by weight. For simplicity, various abbreviations are used in the example and have the meaning given and/or describe materials that are commercially available as noted in the following table.

| Abbreviation | Description/Commercial Source |
|---|---|
| PEDOT | A mixture of water and 3,4-polyethylenedioxythiophene- |
| | polystyrenesulfonate (cationic) available from H. C. Starck, |
| | Newton, MA as PEDOT VP CH8000 |
| 1-TNATA | 4,4′,4″-tris(N-(2-naphthyl)-N-phenyl-amino)- |
| | triphenylamine available from H. W. Sands Corp., |
| | Jupiter, FL as product number OSA 2290 |
| Dendrimer A | A light-emitting dendrimer according to Example 11 of |
| | International Publication Number WO 02/066552 A1 |
| BAlq | Bis-(2-methyl-8-quinolato)-4-(phenyl-phenolato)- |
| | aluminum-(III), sublimed, available from Eastman Kodak |
| | Company, Rochester, NY |
| Irgacure 369 | 2-benzyl-2-(dimethylamino)-1-(4-(morpholinyl)phenyl) |
| | butanone, available from Ciba Specialty Chemicals |
| | Corporation, Tarrytown, NY as Irgacure 369 |
| Irgacure 184 | 1-hydroxycyclohexyl phenyl ketone, available from Ciba |
| | Specialty Chemicals Corporation, Tarrytown, NY as |
| | Irgacure 184 |
| M7Q film | A 0.1 mm thick surface treated polyethylene terephthalate |
| | film available from Teijin, Osaka, Japan as M7Q |
| Silver | Silver shot obtained from Aldrich Chemical, Milwaukee, |
| | WI as 20,436-6 |
| SR 351HP | Trimethylolpropane triacrylate ester, available from |
| | Sartomer, Exton, PA as SR 351HP |
| ITO | Indium tin oxide |
| Striped pixel ITO | Glass substrate having a region of ITO measuring 50 mm × |
| glass | 50 mm × 0.7 mm, said region comprising a pattern of |
| | adjacent, parallel 75 micrometers wide stripes of ITO |
| | with a pitch of 165 micrometers and a resistance of <20 Ohm/sq, |
| | available from Delta Technologies, Stillwater, MN |
| LTHC | Light-to-heat conversion |
| Raven 760 Ultra | Carbon black pigment, available from Columbian |
| | Chemical Co., Atlanta, GA as Raven 760 Ultra |
| Butvar B-98 | Polyvinyl butyrol resin, available from Solutia, Inc., St. |
| | Louis, MO as Butvar B-98 |
| Joncryl 67 | Acrylic resin available from S.C. Johnson & Sons, |
| | Racine, WI as Joncryl 67 |
| Disperbyk 161 | A dispersant available from Byk-Chemie, USA, |
| | Wallingford, CT as Disperbyk 161 |
| Puradisc filter | A 0.20 micrometer PTFE filter available from Whatman |
| | Inc., Clifton, NJ under the tradename Puradisc |
| Aluminum | Puratronic aluminum shots, 99.999%, available from Alfa |
| | Aesar, Ward Hill, MA |
| FC Surfactant | A fluorochemical surfactant prepared according to |
| | Example 5 of U.S. Pat. No. 3,787,351 |
| Ebecryl 629 | An epoxynovolac acrylate available from UCB Radcure |
| | Inc., N. Augusta, SC as Ebecryl 629 |
| Elvacite 2669 | An acrylic resin available from ICI Acrylics Inc., |
| | Memphis, TN as Elvacite 2669 |
| Alq3 | Tris(8-hydroxyquinolato) aluminum, resublimed, |
| | available from H. W. Sands Corp., Jupiter, FL as product |
| | number ORA4487 |
| LiF | Lithium fluoride, 99.85%, available as product number 36359 from Alfa |
| | Aesar, Ward Hill, MA |

Materials used in Example 1 and not identified in the foregoing table may be obtained from Aldrich Chemical Company, Milwaukee, Wis.

Example 1 illustrates a method of making an organic electroluminescent device according to the invention. A donor element that includes a transfer portion comprising at least one layer consisting of one or more light-emitting dendrimers is provided, a receptor is provided, and the transfer portion of the donor element is thermally transferred to the receptor.

Preparation of Donor Element

A donor element is prepared as follows. A LTHC solution is prepared by mixing 3.55 parts Raven 760 Ultra, 0.63 part Butvar B-98, 1.90 parts Joncryl 67, 0.32 part Disperbyk 161, 0.09 part FC Surfactant, 12.09 part Ebecryl 629, 8.06 parts Elvacite 2669, 0.82 part Irgacure 369, 0.12 part Irgacure 184, 45.31 parts 2-butanone, and 27.19 parts 1,2-propanediol monomethyl ether acetate. This solution is coated onto M7Q film with a Yasui Seiki Lab Coater, Model CAG-150, fitted with a microgravure roll having 150 helical cells per inch. The LTHC layer is in-line dried at 80° C. and cured under UV radiation supplied by a Fusion UV Systems Inc. 600 Watt D bulb at 100% energy output (UVA 320 to 390 nm) with an exposure speed of 6.1 m/min.

An interlayer solution is made by mixing 14.85 parts SR 351HP, 0.93 part Butvar B-98, 2.78 parts Joncryl 67, 1.25 parts Irgacure 369, 0.19 part Irgacure 184, 48 parts 2-butanone, and 32 parts 1-methoxy-2-propanol. This solution is coated onto the cured LTHC layer by a rotogravure method using a Yasui Seiki lab coater, Model CAG-150, fitted with a microgravure roll having 180 helical cells per lineal inch. The interlayer is in-line dried at 60° C. and cured under UV radiation supplied by passing the coated layer under a Fusion UV Systems Inc. 600 Watt D bulb at 60% energy output (UVA 320 to 390 nm) at 6.1 m/min.

A layer consisting of light-emitting dendrimer is prepared by dissolving and diluting Dendrimer A under inert conditions with anhydrous toluene to 2.21% by weight. The resulting solution is stirred for one hour, filtered twice through a Puradisc filter, and spin-coated under inert conditions onto the interlayer to yield a transfer layer and having a dry thickness of 40 nm.

Preparation of Receptor

A receptor is prepared is as follows. PEDOT is filtered twice using a Puradisc filter and spin-coated onto a striped pixel ITO glass substrate to yield a buffer layer having a dry thickness of 60 nm. The buffer layer-coated glass substrate is baked for 5 minutes at 200° C. under a nitrogen atmosphere. Using methanol, the buffer layer is selectively removed from portions of the ITO region to provide contact areas for connecting the receptor to a power supply. A 20 nm layer of 1 -TNATA is deposited under a vacuum of approximately 10⁻⁶ Torr and through a rectangular shadow mask on top of the buffer layer to provide a hole transport layer.

Preparation of Organic Electroluminescent Device

Using laser-induced thermal imaging, the LTHC layer, the interlayer and the layer consisting of light-emitting dendrimer are thermally transferred in an imagewise fashion from the donor element to the receptor. One laser is used at a power of 16 watts in a unidirectional scan with a triangle dither pattern and frequency of 400 KHz. The requested line width is 100 micrometers with a pitch of 225 micrometers, and the dose is 0.550 J/cm².

After the thermal transfer, an electron transport layer is formed by depositing a 100 Å thick BAlq layer on the layer consisting of light-emitting dendrimer, followed by a 200 Å thick Alq3 layer. A cathode is then applied by sequentially depositing a 7 Å thick LiF layer followed by a 40 Å thick Aluminum layer. Each cathode layer is deposited through a hole-blocking mask that covers all of the imaged transfer portion. A mask change is made after depositing the aluminum cathode layer to allow connection between the cathode and the ITO contact area. Finally, under a vacuum of approximately 10⁻⁶ Torr, a 4000 Å thick layer of Silver is deposited over the aluminum.

The invention is amenable to various modifications and alternative forms, specifics thereof having been shown by way of example in the foregoing drawings and description. It will be understood, however, that the invention is not limited to these particular embodiments. On the contrary, the intention is to cover all modifications, equivalents and alternatives falling within the spirit and scope of the invention which is defined by the appended claims. Various modifications and equivalent processes, as well as numerous structures to which the present invention may be applicable, will be readily apparent to those of skill in the art to which the present invention is directed. Each of the patents, patent documents, and publications cited above is hereby incorporated into this document as if reproduced in full.

1. A method of making an organic electroluminescent device, the method comprising:
providing a donor element comprising a substrate and a transfer portion disposed on the substrate, the transfer portion comprising at least one transfer layer consisting of one or more light-emitting dendrimers;
providing a receptor; and
thermally transferring the transfer portion of the donor element to the receptor.

2. The method of claim 1, wherein the donor element further comprises a light-to-heat conversion layer disposed between the substrate and the transfer portion.

3. The method of claim 2, wherein the donor element further comprises an interlayer disposed between the light-to-heat conversion layer and the transfer portion.

4. The method of the claim 2, wherein the donor element further comprises an underlayer disposed between the substrate and the light-to-heat conversion layer.

5. The method of claim 1, wherein the transfer portion further comprises a second transfer layer.

6. The method of claim 6, wherein the second transfer layer comprises a material that produces, conducts or semi-conducts a charge carrier.

7. The method of claim 1, wherein the light emitting dendrimer is fluorescent.

8. The method of claim 1, wherein the light emitting dendrimer is phosphorescent.

9. The method of claim 1, wherein the at least one transfer layer consists of more than one light emitting dendrimer.

10. The method of claim 1, wherein the donor element is directly heated to thermally transfer the transfer portion to the receptor.

11. The method of claim 1, wherein the donor element is exposed to imaging radiation that is converted into heat to thermally transfer the transfer portion to the receptor.

12. The method of claim 11, wherein the donor element further comprises a light-to-heat conversion layer that converts the imaging radiation into heat.

13. The method of claim 12, wherein the donor element is exposed to imaging radiation through a mask.

14. The method of claim 12, wherein the donor element is exposed to imaging radiation generated by a laser.

15. The method of claim 11, wherein the donor element and the receptor are held in intimate contact during thermal transfer of the transfer portion to the receptor.

16. The method of claim 11, wherein the donor element and the receptor are spaced apart during thermal transfer of the transfer portion to the receptor.

17. The method of claim 11, wherein the transfer portion is thermally transferred to the receptor in an imagewise fashion to form a pattern on the receptor.
